(19) United States
(12) Patent Application Publication
(10) Pub. No.: US 2009/0083162 A1
(43) Pub. Date: Mar. 26, 2009

(54) System and method for providing delivery of goods

(75) Inventor: George C. Rimnac, JR., Long Grove, IL (US)

Correspondence Address: GREENBERG TRAURIG, LLP, 77 WEST WACKER DRIVE, SUITE 3100, CHICAGO, IL, 60601-1732, US

(73) Assignee: W.W. Grainger, Inc., Lake Forest, IL (US)

(21) Appl. No.: 11/903,366

(22) Filed: Sep. 21, 2007

(51) Int. Cl. G06Q 30/00; G06F 17/00; G06F 17/30

(52) U.S. Cl. 705/26

(57) ABSTRACT

In connection with the delivery of goods ordered by a customer, a system and method functions to use information associated with the customer and/or goods ordered by the customer to determine additional goods that are likely to be of interest to the customer. The additional goods may then be included on a delivery vehicle whereupon the additional goods may be offered for sale to the customer. The offer for sale may be made directly from the delivery vehicle or by stocking and offering the additional goods at a wholesaler location, such as a vending machine, wholesaler branch location, etc.

### BACKGROUND

The following relates generally to commerce and, more particularly, relates to a system and method for providing delivery of goods.

In the art, systems and methods for providing delivery of goods are known. For example, U.S. Pat. No. 7,251,612 discloses systems and methods for dynamically scheduling the distribution of goods among a system of routes and timeslots; U.S. Pat. No. 7,117,825 discloses systems and methods for receiving customer orders for selected goods via a data network, fulfilling the customer orders, and delivering the ordered goods to the customers at a specified delivery date, time, and location; and U.S. Pat. No. 6,871,184 discloses systems and methods for delivering goods ordered over the Internet where the order is filled at a warehouse, the goods are placed in a tote for delivery, the totes are transferred to a first vehicle, typically a large trailer, that transports the totes to a transfer point, and the totes and an accompanying bill of lading are transferred to a second smaller vehicle, such as a van, for delivery to a customer.

### SUMMARY

An improved system and method for delivering goods to an ordering customer is provided. Generally, in connection with the delivery of goods ordered by a customer, the system and method functions to use information associated with the customer and/or goods ordered by the customer to determine additional goods that are likely to be of interest to the customer. The additional goods may then be included on a delivery vehicle whereupon the additional goods may be offered for sale to the customer. The offer for sale may be made directly from the delivery vehicle or by stocking and offering the additional goods at a wholesaler location, such as a vending machine, wholesaler branch location, etc.

A better understanding of the objects, advantages, features, properties and relationships of the system and method described hereinafter will be obtained from the following detailed description and accompanying drawings which set forth illustrative embodiments which are indicative of the various ways in which the principles of the invention may be employed.

### BRIEF DESCRIPTION OF THE DRAWINGS

For a better understanding of the system and method for providing delivery of goods described hereinafter, reference may be had to preferred embodiments shown in the following drawings in which:

FIG. 1 illustrates a block diagram of an exemplary computer system in which the principles of the described invention may be employed; and

FIG. 2 illustrates a flow chart diagram of an exemplary method for providing delivery of goods to an ordering customer.

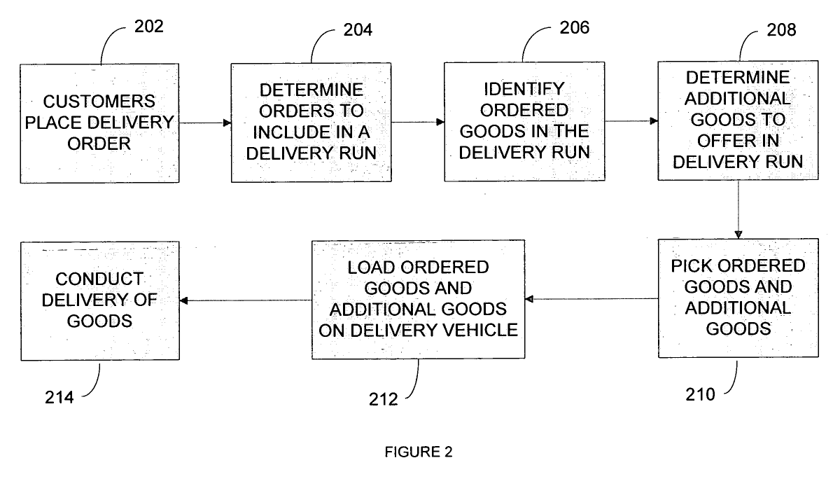

### DETAILED DESCRIPTION

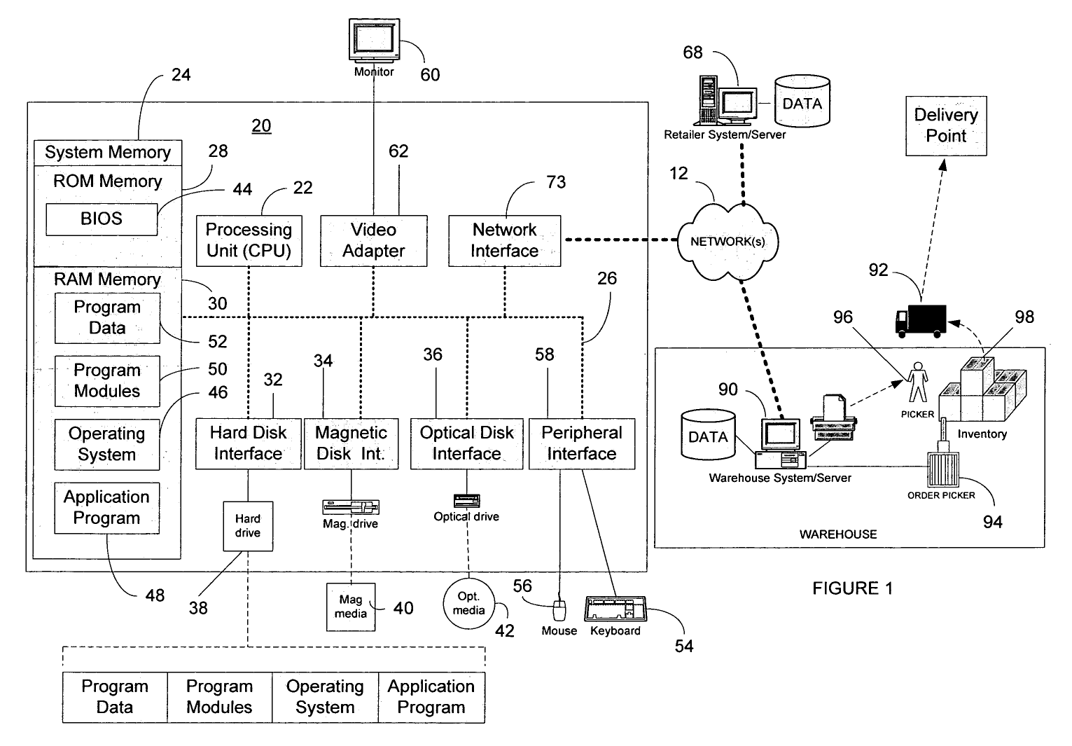

Turning to the drawings, wherein like reference numerals refer to like elements, an exemplary system and method for providing delivery of goods is hereinafter described. As illustrated in FIG. 1, the exemplary system includes a processing device 20, illustrated in the exemplary form of a computer system, that is provided with executable instructions to, for example, provide a means for a customer to access a wholesaler web site via a wholesaler computer system/server 68 and thereby browse goods offered for sale by the wholesaler, purchase goods of interest, request delivery of goods etc. Generally, the computer executable instructions reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular telephone, or the like. Furthermore, while described and illustrated in the context of a single processing device 20, those skilled in the art will also appreciate that the various tasks described hereinafter may be practiced in a distributed environment having multiple processing devices linked via a local or wide-area network whereby the executable instructions may be associated with and/or executed by one or more multiple processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of well known bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the processing device 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules, i.e., computer executable instructions, may be stored in one or more of the memory/media devices of the processing device 20. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to the processing device 20 as needed, for example, via a network connection.

The customer may enter commands and information into the processing device 20 through input devices such as a keyboard 54 and/or a pointing device 56. While not illustrated, other input devices may include a microphone, a joystick, a game pad, a scanner, etc. These and other input/output devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

As further illustrated in FIG. 1, the processing device 20 may also utilize logical connections to one or more remote processing devices, such as the wholesaler system/server 68. As is conventional, the remote processing devices may have an associated data repository in which is stored data such as customer information, electronic catalog pages, etc. While the remote processing device 68 has been illustrated in the exemplary form of a server computer, it will be appreciated that the remote processing devices 68 may be any type of device having processing capabilities. As such, it will again be appreciated that the remote processing device 68 need not be implemented as a single device but may be implemented in a manner such that the tasks performed by the remote processing device 68 are distributed to a plurality of processing devices linked through a communication network

For performing tasks as needed, the remote processing device 68 and other processing devices illustrated in FIG. 1, such as warehouse system/server 90, may include many or all of the elements described above relative to the processing device 20. Communications between the processing device 20 and these additionally illustrated processing devices may be exchanged via a further processing device, such a network router, that is responsible for network routing. Communications with the network router may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the memory storage device(s) of one or more of these additionally illustrated processing devices.

As illustrated in FIG. 1 and as noted above, a customer generally interacts with wholesaler system/server 68 to browse an electronic catalog of goods offered for sale by the wholesaler, to order/purchase goods of interest, and request delivery of such goods 202. In connection with the ordering/purchasing of goods, or at some other time, the wholesaler system/server 68 may also communicate with a warehouse system/server 90 to determine if the goods of interest to the customer are in stock and/or available for delivery. This availability information may also be maintained at the wholesaler system/server 68 without limitation. If the goods of interest to the customer are not in stock or not available for delivery, the customer may be so notified and provided with ordering alternatives in a conventional manner.

In the event that the customer ordered goods are in stock and available for delivery, the wholesaler system/server 68, the warehouse system/server 90, or both in cooperation, i.e., individually or collectively “the system,” functions to coordinate delivery of ordered goods to one or more customers. In this regard, the goods may be delivered to the customer(s) as part of an ad hoc or scheduled order fulfillment process. To this end, the system will generally function to determine 204 which customer order(s) are to be included in a single delivery run 214, usually with the goal of maximizing the efficiency of delivery. As is conventional, once it is determined which customer order(s) are to comprise a delivery run, the system will function to have the goods that are specified within the customer order(s) that comprise the delivery run 206 picked 210 from inventory 98 and staged, binned, etc. for loading 212 onto the delivery vehicle 92. In a conventional manner, the process of picking the goods from warehouse inventory 98 and staging the goods for loading onto the delivery vehicle 92 may be performed utilizing automated order picker(s) 94 and/or manual picker(s) 96 that are provided electronic or hard copy pick and pack listings, respectively.

In connection with the picking, packing, and staging of goods within customer order(s) that are to comprise a delivery run, the system further functions to use information relevant to the customer order(s) that are to comprise a delivery run to determine 208 which additional items, if any, might be desired to be included on the delivery vehicle 92 for inducing possible on-the-spot sales to customers and/or future sales. For determining the additional goods to be included on a delivery run, the system may consider, without limitation, information such as prior purchasing history of a customer, prior purchasing history of a group of customers, prior purchases of goods made at the same time, equipment operated by a customer, scheduled maintenance activity of a customer, prior maintenance activity of a customer, etc. Without limitation, the system may utilize one or more of the methods described in commonly assigned U.S. Published Application No. 2005/0171860 or those described in U.S. Pat. Nos. 6,317,722 and 6,064,980 to identify additional good(s) which are to be included on a delivery run as a function of various types of customer/order/demographic/etc. information.

By way of example only, the system may consider each good specified within a customer order and then suggest for inclusion with the delivery run additional good(s) that: a) have been determined to be most often purchased with one or more of the goods specified within the customer order; and (b) are not already included as a part of the customer order. By way of still further example, the system may consider each good specified within a customer order for the purpose of determining if the goods are part of an identifiable family of goods, e.g., at least a portion of the goods specified are within the family of goods commonly used in a maintenance activity such as cooling system maintenance, and then suggest for inclusion with the delivery run additional good(s) that: a) are within the identified family of goods; and b) are not already included as a part of the customer order. Yet further, the system may consider the prior purchasing history of the customer and then suggest for inclusion with the delivery run additional good(s) that have been frequently purchased by the customer but not included as a part of their order, additional good(s) that are useful in repairing or maintaining equipment or other goods previously purchased by the customer, etc. As will be appreciated, while the system may determine a myriad of different possible additional goods to include within a delivery run, the system may further function to filter and select for inclusion on a delivery run those good(s) that have been determined to have the highest probability of resulting in a sale. In performing this filtering process, the system may also take into consideration available space on the delivery vehicle.

Once the additional goods to include on a delivery vehicle have been determined, the additional goods may be placed into bins that could be loaded onto the delivery vehicle as needed before an ad hoc or scheduled delivery run and then removed, if need be, immediately after a delivery run. In addition, multi-shelved rolling racks can be used to house bins that carry additional goods that are seen to be commonly suggested for inclusion on delivery runs. The rolling racks can be designed to allow aggregation of these bins. These racks could be rolled on and off the delivery vehicles as needed. These racks could be preconfigured in a way that they are used over and over, each time a delivery is made to a given customer or to a customer in a given industry segment.

To allow the delivery agent to be able to complete a sales transaction for one of more of the goods that were additionally added to the delivery vehicle during a delivery run 214, the system may further provide for credit card billing, account debiting, or the like type of financial transactions to be performed at the time of delivery. By way of example, a transaction can be accomplished by placing a delivery vehicle device into communication with the wholesaler system/server 68 by means of the network. In this manner, the remote connection into the wholesaler system/server 68 can be used to perform sales of any of the additional goods on the spot, allow for the ordering of any of the additional goods for delivery in the future, and/or allow for other e-commerce related actions to be performed in conventional manners.

While specific embodiments of the invention have been described in detail, it will be appreciated by those skilled in the art that various modifications and alternatives to those details could be developed in light of the overall teachings of the disclosure. For example, it will be appreciated that the initial order for goods need not be limited to being provided by interaction with a web site but may originate via a phone call, email, etc. Furthermore, the initial order for goods may be made in connection with a request to restock a vending machine, a consignment location, a wholesaler branch location, etc. with the additional, upsell goods then being placed onto the delivery vehicle to be used to stock the vending machine, consignment location, wholesaler branch location, etc. with both the ordered goods and the additional, upsell goods. Accordingly, the particular arrangement disclosed is meant to be illustrative only and not limiting as to the scope of the invention which is to be given the full breadth of the appended claims and any equivalents thereof.

All patents, patent applications, and other references cited within this document are hereby incorporated by reference in their entirety.

What is claimed is:

1. A method for providing delivery of goods, comprising:
receiving from a customer a request which specifies a good for delivery;
determining one or more additional goods likely to be purchased with the good specified for delivery;
including the good specified for delivery and the one or more additional goods on a delivery vehicle;
delivering from the delivery vehicle to the customer the goods specified for delivery; and
in connection with delivery of the goods specified for delivery causing the one or more additional goods included on the delivery vehicle to be made available for purchase by the customer.

2. The method as recited in claim 1, wherein determining one or more additional goods likely to be purchased with the good specified for delivery comprises considering a purchasing history of the customer.

3. The method as recited in claim 1, wherein determining one or more additional goods likely to be purchased with the good specified for delivery comprises considering other goods purchased with the good specified for delivery.

4. The method as recited in claim 1, wherein determining one or more additional goods likely to be purchased with the good specified for delivery comprises considering maintenance history of a piece of equipment operated by the customer.

5. The method as recited in claim 1, wherein determining one or more additional goods likely to be purchased with the good specified for delivery comprises considering purchasing history of other customers having one or more demographic characteristics in common with the customer.

6. The method as recited in claim 1, comprising offering to the customer the one or more additional items for sale directly from the delivery vehicle.

7. The method as recited in claim 1, comprising stocking the one or more additional items within a vending machine for sale to the customer.

8. The method as recited in claim 1, comprising using an automated system to pick and pack the good specified for delivery and the one or more additional goods for placement on the delivery vehicle.

9. The method as recited in claim 1, comprising packing the one or more additional goods within a bin housable on a rolling rack.

10. A computer-readable media having embedded computer executable instruction for use in connection with providing delivery of goods, the instructions performing steps comprising:
receiving from a customer a request which specifies a good for delivery;
determining one or more additional goods likely to be purchased with the good specified for delivery; and
causing the good specified for delivery and the one or more additional goods to be picked and packed for loading on a delivery vehicle whereupon, in connection with the delivering of the goods specified for delivery to the customer, the one or more additional goods included on the delivery vehicle are made available for purchase by the customer.

11. The computer-readable media as recited in claim 10, wherein the instructions process a payment made in connection with a purchase of one or more additional goods included on the delivery vehicle.

12. The computer-readable media as recited in claim 10, wherein the instructions determine one or more additional goods likely to be purchased with the good specified for delivery by considering other goods purchased with the good specified for delivery.

13. The computer-readable media as recited in claim 10, wherein the instructions determine one or more additional goods likely to be purchased with the good specified for delivery by considering maintenance history of a piece of equipment operated by the customer.

14. The computer-readable media as recited in claim 10, wherein the instructions determine one or more additional goods likely to be purchased with the good specified for delivery by considering purchasing history of other customers having one or more demographic characteristics in common with the customer.
